(19) United States
(12) Patent Application Publication
(10) Pub. No.: US 2024/0320413 A1
(43) Pub. Date: Sep. 26, 2024

(54) INFORMATION PROCESSING DEVICE, LINK ADDING METHOD, AND RECORDING MEDIUM

(71) Applicant: CASIO COMPUTER CO., LTD., Tokyo (JP)

(72) Inventors: Noritaka KOMIYAMA, Tokyo (JP); Yoshihiro TAKAYAMA, Tokyo (JP)

(73) Assignee: CASIO COMPUTER CO., LTD., Tokyo (JP)

(21) Appl. No.: 18/613,599

(22) Filed: Mar. 22, 2024

(30) Foreign Application Priority Data
Mar. 24, 2023 (JP) 2023-049066

(51) Int. Cl. G06F 40/134; G06F 40/279

(52) U.S. Cl. CPC G06F 40/134; G06F 40/279

(57) ABSTRACT

An information processing device includes a memory storing a program, and a controller that executes the program. The controller detects, from within text included in a display request page, for which displaying is requested from a terminal, a keyword associated with a subject to be displayed; and adds, to the keyword within the text, a link to a page related to the subject to be displayed identified by the keyword.

### CROSS-REFERENCE TO RELATED APPLICATIONS

This application claims the benefit of Japanese Patent Application No. 2023-049066, filed on Mar. 24, 2023, the entire disclosure of which is incorporated by reference herein.

### FIELD OF THE INVENTION

This application relates generally to an information processing device, a link adding method, and a recording medium.

### BACKGROUND OF THE INVENTION

Non-Patent Literature: Product introduction, Morinaga Milk Industry Co., Ltd. (online, Mar. 22, 2023 search results), Internet, URL: https://www.morinagamilk.co.jp/english/products/describes a technology for adding a link in a webpage of a product introduction site that introduces products, and enabling easy access to a product detail page, a purchase page, or the like by following that link.

### SUMMARY OF THE INVENTION

An information processing device according to the present disclosure is
an information processing device including a memory storing a program, and at least one processor that executes the program, wherein
the processor
   detects, from within text included in a display request page, for which displaying is requested from a terminal, a keyword associated with a subject to be displayed, and
   adds, to the keyword within the text, a link of a page related to the subject to be displayed identified by the keyword.

### BRIEF DESCRIPTION OF DRAWINGS

A more complete understanding of this application can be obtained when the following detailed description is considered in conjunction with the following drawings, in which:

FIG. 1 is a drawing illustrating the overall configuration of a watch introduction system according to an embodiment of the present disclosure;

FIG. 2 is a block diagram illustrating the configuration of a user terminal according to an embodiment of the present disclosure;

FIG. 3 is a block diagram illustrating the configuration of an information processing device according to an embodiment of the present disclosure;

FIG. 4 is a drawing illustrating a configuration example of user data stored in a user database according to an embodiment of the present disclosure;

FIG. 5 is a drawing illustrating a configuration example of watch data stored in a watch database according to an embodiment of the present disclosure;

FIG. 6 is a drawing illustrating an example of a detail screen according to an embodiment of the present disclosure;

FIG. 7 is a flowchart of page display processing according to an embodiment of the present disclosure;

FIG. 8 is a drawing illustrating an example of a latest news page before links are added, according to an embodiment of the present disclosure;

FIG. 9 is a drawing illustrating an example of the latest news page after links are added, according to an embodiment of the present disclosure; and

FIG. 10 is a drawing illustrating an example of a list display page after links are added, according to an embodiment of the present disclosure.

### DETAILED DESCRIPTION OF THE INVENTION

Hereinafter, an information processing device according to embodiments of the present disclosure is described in detail while referencing the drawings. Note that, in the drawings, identical or corresponding components are denoted with the same reference numerals.

FIG. 1 is a configuration drawing of a watch introduction system 1 provided with an information processing device according to an embodiment of the present disclosure. The watch introduction system 1 is a product introduction system for introducing a specific watch to a user. Additionally, the user can purchase the introduced watch via the watch introduction system 1. The watch introduction system 1 includes a user terminal 100 that is used by the user, and an information processing device 200 that manages a watch introduction site. The user terminal 100 and the information processing device 200 are communicably connected to each other across an internet 300, which is an example of a communication network.

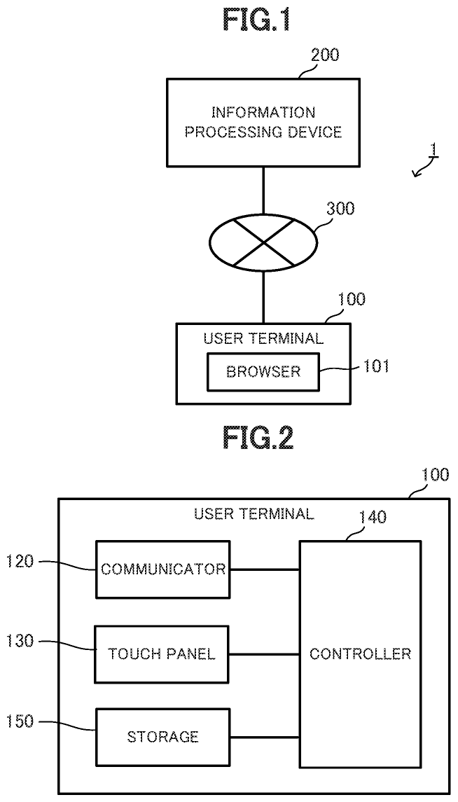

The user terminal 100 is a smartphone, a tablet terminal, or the like that is used by the user. A browser 101 is installed on the user terminal 100, and the user can search for, view, purchase, and the like a watch by accessing, via the browser 101, the watch introduction site provided by the information processing device 200. As illustrated in FIG. 2, the user terminal 100 includes a communicator 120, a touch panel 130, a controller 140, and a storage 150.

The communicator 120 is an interface whereby the user terminal 100 communicates with the information processing device 200 across the internet 300.

The touch panel 130 is a device that has both a function of displaying various types of information on a screen and a function as a pointing device that operates a pointer on the screen. In one example, a detail page of a watch, a list page of watches, or the like is displayed on the touch panel 130.

The controller 140 includes a central processing unit (CPU), read-only memory (ROM) that stores programs such as an operating system (OS) and the like, random access memory (RAM) that serves as the working area, and the like, and controls the entire user terminal 100. Note that, the controller 140 may comprise a plurality of processors.

The storage 150 has a role as a so-called secondary storage device (auxiliary storage device) and, in one example, is implemented as read/write non-volatile flash memory, hard disk drive, or the like. Various types of data and programs to be executed by the controller 140 are stored in the storage 150.

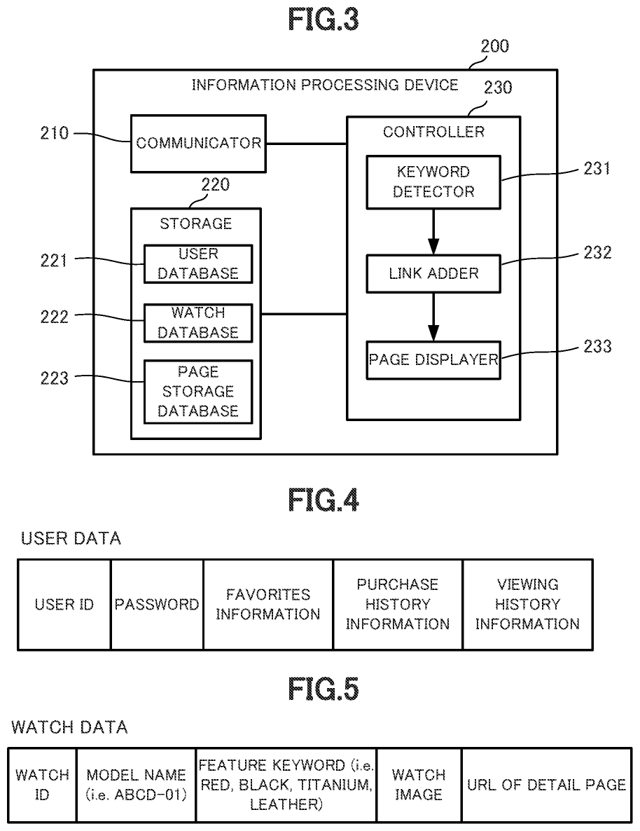

Returning to FIG. 1, the information processing device 200 is a web server that manages the watch introduction site. In response to requests from the user terminal 100, the information processing device 200 displays various types of screens on the browser 101 of the user terminal 100, executes various types of processing, and the like. As illustrated in FIG. 3, the information processing device 200 includes a communicator 210, a storage 220, and a controller 230.

The communicator 210 is an interface for communicating with the user terminal 100 across the internet 300.

The storage 220 has a role as a so-called secondary storage device (auxiliary storage device) and, in one example, is implemented as read/write non-volatile flash memory, hard disk drive, or the like. Various types of data and programs to be executed by the controller 230 are stored in the storage 220. In one example, a user database 221, a watch database 222, and a page storage database 223 are stored in the storage 220.

The user database 221 is a database in which user data, of each user registered as a member of the watch introduction system 1, is stored. As illustrated in FIG. 4, the user data includes a user ID, a password, favorites information, purchase history information, viewing history information, and the like of the user. The favorites information indicates watches that the user has marked as favorites of the user. The purchase history information indicates a purchase history of watches purchased by the user on the watch introduction system 1. The viewing history information indicates a viewing history of watches viewed by the user on the watch introduction system 1.

The watch database 222 is a database in which data (watch data), related to the various watches handled by the watch introduction system 1, is stored. As illustrated in FIG. 5, the watch data includes identification information, namely a watch ID, a model name, a feature keyword, a watch image, a URL of the detail page, and the like, of each watch.

The model name of the watch data is identification information that uniquely identifies a certain watch, similar to the watch ID. In the present embodiment, the model name is expressed in a format such as “ABCD-01”, in which four English uppercase characters representing an upper classification and a two-digit number, assigned sequentially starting from the oldest model, representing a lower classification are connected by a hyphen.

The feature keyword of the watch data is a word expressing a watch feature such as a watch color such as “red” or “black”, a watch material such as “titanium” or “leather”, or the like. A plurality of feature keywords are set in the watch data of a watch that has a plurality of features.

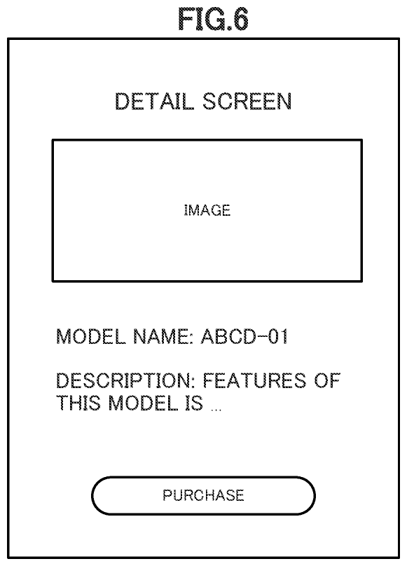

The URL of the detail page of the watch data is a URL of a webpage (detail page) on which a detailed description of a certain watch is provided. FIG. 6 illustrates an example of a detail screen. A “Purchase” button is displayed in a lower portion of this detail screen. The user can access a page for purchasing the watch by clicking, via the touch panel 130, the “Purchase” button.

Returning to FIG. 3, data of each webpage in the watch introduction site, including the detail page described above and other pages, is stored in the page storage database 223. Links to detail pages are not added to the text included in each page stored in the page storage database 223.

The controller 230 includes a CPU, a ROM that stores programs such as an OS, a RAM that serves as the working area, and the like. The controller 230 controls the entire information processing device 200. Note that, the controller 230 may comprise a plurality of processors. The controller 230 includes, as a functional configuration according to the present embodiment, a keyword detector 231, a link adder 232, and a page displayer 233.

The keyword detector 231 detects, from within text included in a display request page, for which displaying is requested from the user terminal 100, the model name that is a keyword identifying a watch. The keyword detector 231 detects, from within the same text, a feature keyword expressing a feature of the watch.

The link adder 232 adds, to the model name detected by the keyword detector 231, a link to the detail page of the watch identified by the model name Additionally, the link adder 232 adds, to the detected feature keyword, a link to a page that displays, in a list, watches that have the feature expressed by the feature keyword.

The page displayer 233 displays, on the browser 101 of the user terminal 100, a display request page to which links are added by the link adder 232.

Note that details of processings of the keyword detector 231, the link adder 232, and the page displayer 233 are described later.

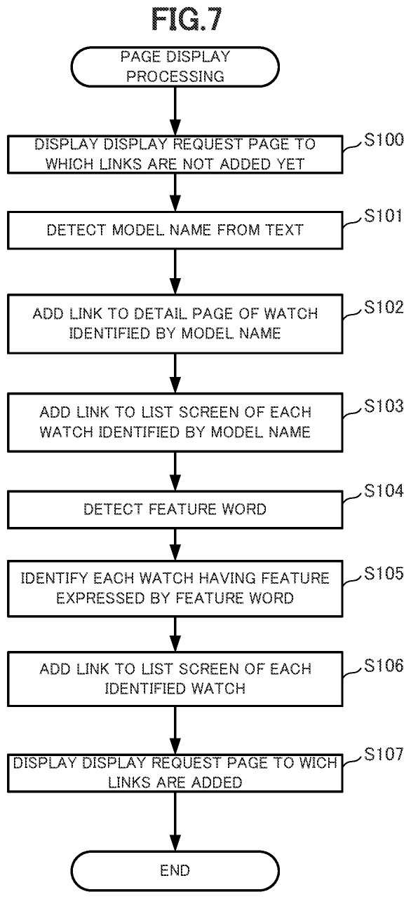

Next, the operations of the information processing device 200 are described. In one example, the user performs, from the touch panel 130 of the user terminal 100, an operation for displaying a specific page of the watch introduction site. In response to this operation, the controller 140 of the user terminal 100 sends a display request for that page to the information processing device 200. When the display request for the page is received from the user terminal 100, the controller 230 of the information processing device 200 executes page display processing illustrated in FIG. 7.

Firstly, the controller 230 (the keyword detector 231) displays, on the screen of the browser 101 of the user terminal 100, the page (the display request page) for which displaying is requested (step S100). The page includes text and images. Links are not yet added to the page displayed at this time. Note that a configuration is possible in which the displaying of step S100 is omitted and only the displaying of step S107, described later, is performed.

Next, the controller 230 (the keyword detector 231) reads out, from the watch database 222, the model name to be detected, and detects, from within the text included in the page (the display request page) for which displaying is requested, the read out model name, more specifically, the model name that is a keyword identifying a watch handled by the watch introduction site (step S101). Here, in step S101, the model name is exhaustively searched for using regular expressions. That is, watches are extracted not only for cases in which the model name matches perfectly, but also in cases in which only the upper classification portion, that is, the four leading characters of the model name, match. For example, when the model name is “ABXY-01”, “ABXY-” is detected even when only “ABXY-” is included within the text. The model name to be detected may be information that can uniquely identify a watch product, or may be information expressing a product group (a brand, a sub-brand, a base model, or the like) into which a plurality of watch products can be classified.

Next, the controller 230 (the link adder 232) acquires, from the watch database 222, the URL of the detail page of the watch identified by the model name detected in step S101, and adds a link to that URL to the portion of the model name within text (step S102). Note that, at this time, when only the upper classification of the model name is detected in step S101, a plurality of watches may be identified from that upper classification. In such a case, the controller 230 identifies, from among the plurality of watches, the watch for which the number of the lower classification is the smallest (that is, the oldest model) as a representative watch, and adds a link to the URL of the detail page of that watch. For example, when there are three model names, namely “ZZZZ-01”, “ZZZZ-02”, and “ZZZZ-03” identifiable by the upper classification “ZZZZ-” of the model name detected from the text, a link to a product detail page of the model name “ZZZZ-01” is added to the “ZZZZ-” portion.

Note that, when a plurality of model names is detected in step S101, the processing of step S102 is executed for every detected model name, and a link to the product detail page corresponding to each model name of the plurality of model names is added.

After step S102, the controller 230 (the link adder 232) adds, at a desired location within the page for which displaying is requested, a link to a page that displays the various watches, identified by each model name detected in step S101, in a list (step S103). Note that a configuration is possible in which the processing of step S103 is executed immediately after the processing of step S101.

Next, the controller 230 (the keyword detector 231) detects, from within the text included in the page for which displaying is requested, a feature keyword expressing a watch feature (step S104). Then, the controller 230 references the watch database 222 and identifies all of the watches that have the feature expressed by the detected feature keyword (step S105). Next, the controller 230 (the link adder 232) adds, to the feature keyword portion within the text, a link to a page that displays the various watches identified in step S105 in a list (step S106). Note that, when a plurality of feature keywords is detected in step S104, the processing of steps S105 and S106 is executed for every detected feature keyword, and a link is added to each feature keyword of the plurality of feature keywords. Note that a configuration is possible in which the processing of steps S104 to S106 is performed at the start of the page display processing.

Next, the controller 230 (the page displayer 233) updates the page to which links are not added that is displayed on the screen of the browser 101 of the user terminal 100 in step S100, and displays, on the screen of the browser 101 of the user terminal 100, a page in which the links are added in steps S102, S103, and S106 (step S107). Specifically, the screen display of the browser 101 of the user terminal 100 switches from a state in which a page without links is displayed to a state in which the page with links is displayed. Note that a configuration is possible in which, after the displaying of step S100, the displaying of step S107 is carried out after a predetermined amount of time elapses (for example, after five seconds). Additionally, a configuration is possible in which a confirmation button is displayed before step S107 or the like, an operation for confirming whether to add links is received from the user and, when confirmation is obtained, the displaying of step S107 is carried out. By configuring in this manner, the user can also confirm the text prior to the links being added. Then, the page display processing is ended.

Next, as one example, a case is described in which displaying of a page containing the latest news (latest news page) is requested from the user terminal, and the page display processing is executed.

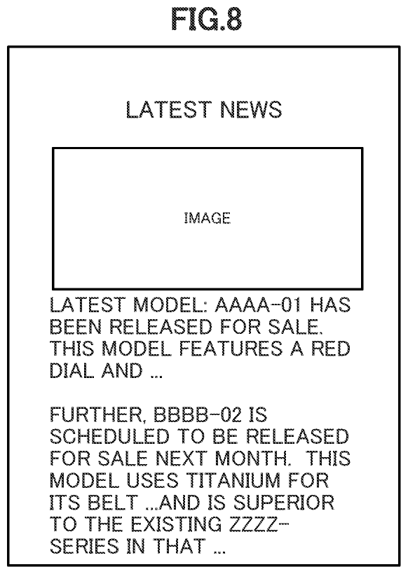

FIG. 8 is a drawing illustrating an example of a latest news page, data representing said page being stored in the page storage database 223. At a stage immediately before the start of the execution of the page display processing, the latest news page consists of only an image and a text portion, and there are no links to other pages added.

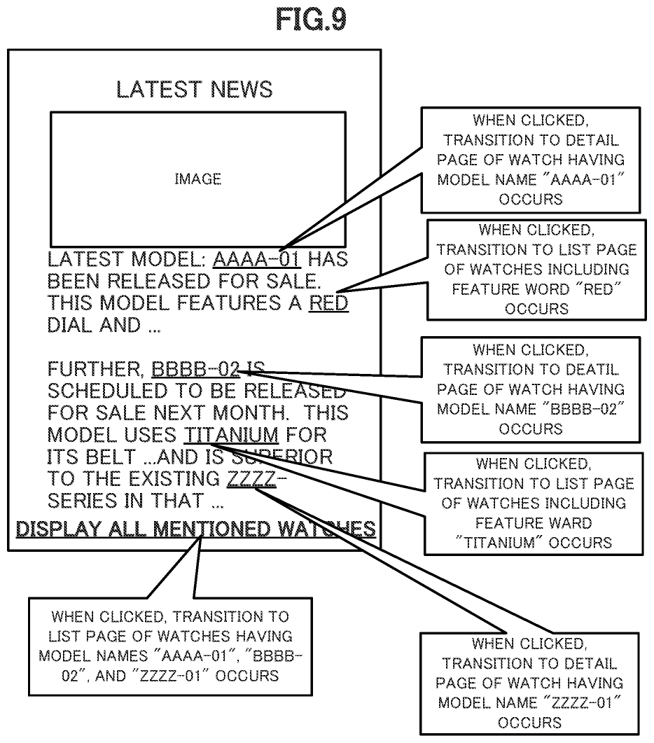

Moreover, when page display processing, in which the latest news page in this state is to be processed, starts, the latest news page is in a state in which links such as illustrated in FIG. 9 are added. Note that the speech bubbles in FIG. 9 are provided only for convenience in order to describe the links, and such speech bubbles are not provided in the actual latest news page.

Specifically, as a result of the page display processing, the model names “AAAA-01”, “BBBB-02”, and “ZZZZ-” are detected from the text of the latest news page (step S101), and links to the detail pages of the watches identified by the model names are added at each location of these model names (step S102). Note that “ZZZZ-” is only the upper classification portion of the model name, but “ZZZZ-01”, which is the oldest model of the models under “ZZZZ-”, is the representative model name, and a link to the watch identified by the model name “ZZZZ-01” is added.

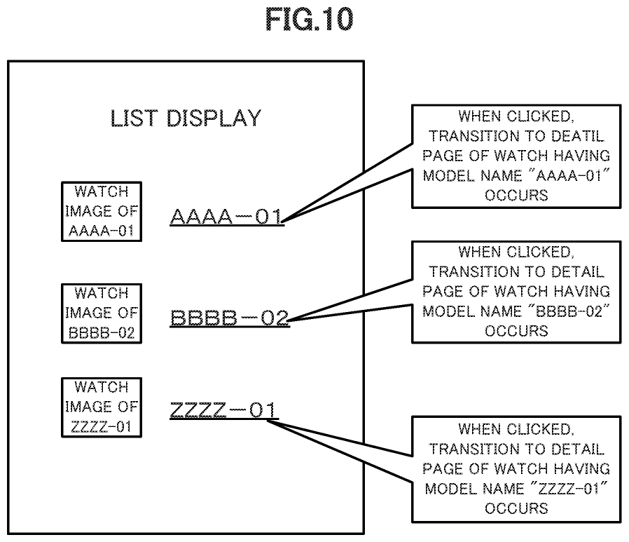

Furthermore, “Display all mentioned watches”, which is a link to a page on which various watches identified by the model names “AAAA-01”, “BBBB-02”, and “ZZZZ-” extracted from the text are displayed as a list, is generated in the lower portion of the latest news page (step S103). FIG. 10 illustrates an example of a list display page that is displayed when “Display all mentioned watches” is clicked. In this example, the model names mentioned on the latest news page and images of the corresponding watches are displayed in a list (FIG. 9). Note that, in this example, the sorting order of the watches displayed as a list is the order of mention on the latest news page, but the watches may be displayed as a list in alphabetical order, or the like. Additionally, links to the detail screens of the corresponding watches are added to the model names and the image portions of the list display page.

Returning to FIG. 9, the feature keyword “red” is detected from the text of the latest news page (step S104). Then, the watches having the feature of the feature keyword “red” are identified (step S105), and a link to a page displaying those various watches as a list is added to the feature keyword “red” portion (step S106). Likewise, the feature keyword “titanium” is detected from the text of the latest news page (step S104). Then, the watches having the feature of the feature keyword “titanium” are identified (step S105), and a link to a page displaying those various watches as a list is added to the feature keyword “titanium” portion (step S106).

Then, the latest news page (FIG. 9) to which such various links are added is displayed on the screen of the browser 101 of the user terminal 100 that requested the displaying (step S107).

When creating a webpage using conventional techniques, there is a problem in that the administrator must manually perform the work of adding links to specific words in the text and, when the number of links to be added is great, this work requires a great deal of effort. In contrast, according to the present embodiment, when displaying of the watch introduction site, which is one type of product introduction site, is requested from the user terminal 100, keywords (model names) identifying products, namely watches, from the text within that page are detected, and links to detail sites of the products identified by the model names are added. As a result, in a product introduction site, it is possible to easily add, to the webpage to be displayed, links to other webpages in real time. Additionally, in the present embodiment, the page display processing (FIG. 6) is executed and the links are added every time a specific page is displayed and, thus, it is possible to always add appropriate links even when the specifications of the product to be introduced change, the product becomes no longer available for sale, or the like. Thus, according to the present embodiment, in a site that displays a subject to be displayed, the work load of adding, to pages to be displayed, links to other pages can be reduced.

In the present embodiment, when a keyword that identifies a plurality of watches (for example, only the upper classification of the model name) is detected from the text of a page to be displayed, a link to a detail page of a representative watch (in the present embodiment, the watch for which the numerical value of the lower classification is the smallest), selected from among the plurality of watches and on the basis of a predetermined criterion, is added to that keyword. As such, an appropriate link can be added to the keyword. Note that a variety of types of criteria for selecting the representative watch from among the plurality of watches can be considered. For example, a tag “representative” or the like may be added in advance to the watch data of the representative watch.

Additionally, in the present embodiment, a feature keyword expressing a watch feature is detected from within the text of the page to be displayed, and a link to a page that displays, as a list, watches that have the feature expressed by the feature keyword is added. As a result, it is possible to add links not only to pages of watches specifically mentioned in the page, but also to pages related a greater number of types of watches.

In the present embodiment, a link to a webpage, on which various watches identified by a keyword detected from within text of the page to be displayed, is also created and, as such, it is possible to enhance the ease-of-use of the product introduction site.

### MODIFIED EXAMPLES

Various modifications can be made to the embodiment described above. For example, in the embodiment described above, an example is described in which the product is a watch, but the present disclosure can also be applied to information processing devices that manage product introduction sites of products other than watches.

In the embodiment described above, the model name is detected as the keyword for identifying the product (the watch), but the keyword for identifying the product is not limited to the model name. For example, a configuration is possible in which a name, a nickname, an abbreviation, or the like of the product is detected from within the text of the page as the keyword for identifying the product.

In the embodiment described above, the link to a detail page of a watch identified by a model name is added to that model name detected from within the text of the page, but a configuration is possible in which a link to another page related to that watch (for example, a purchase page of that watch or the like) is added. In such a case, the URL of the page being linked to must be appropriately set in the watch data of the watch database 222.

In the embodiment described above, the controller 230 of the information processing device 200 executes the page display processing, but a configuration is possible in which the controller 140 of the user terminal 100 executes this processing. In such a case, at the start of the processing, the user terminal 100 must access the information processing device 200 and copy the user database 221, the watch database 222, and the page storage database 223, to the storage 150 of the user terminal 100.

In the embodiment described above, an example is described in which links are added to a webpage related to products (watches) that are the subject to be displayed, but the subject to be displayed of the present disclosure is not limited thereto. For example, the present disclosure can also be applied to a case in which the subject to be displayed is living organisms, vehicles, countries, or the like, and a links are added to webpages that include text of an encyclopedia site that displays information related to the subject to be displayed. Note that, in such a case, data corresponding to the subject to be displayed must be appropriately stored in the storage 220 of the information processing device 200.

A computer may be configured that is capable of realizing the various features described above by storing and distributing a program for realizing the various features of the information processing device on a non-transitory computer-readable recording medium such as a compact disc read-only memory (CD-ROM), a digital versatile disc read-only memory (DVD-ROM), or the like, and installing this program on the computer. Moreover, in cases in which the various functions are realized by being divided between an operating system (OS) and an application, or are realized by cooperation between an OS and an application, it is possible to store only the application on the non-transitory recording medium.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

1. An information processing device comprising:
a memory storing a program; and
at least one processor that executes the program, wherein
the at least one processor
detects, from within text included in a display request page, for which displaying is requested from a terminal, a keyword associated with a subject to be displayed, and
adds, to the keyword within the text, a link to a page related to the subject to be displayed identified by the keyword.

2. The information processing device according to claim 1, wherein the at least one processor displays, on the terminal, the display request page including the keyword to which the link is added.

3. The information processing device according to claim 2, wherein the at least one processor displays, on the terminal, the display request page including the keyword to which the link is not added and then, at a predetermined timing, displays, on the terminal, the display request page including the keyword to which the link is added.

4. The information processing device according to claim 1, wherein in a case in which a keyword identifying a plurality of the subject to be displayed is detected, the at least one processor adds, to the keyword, a link to a page related to a representative subject to be displayed selected based on a predetermined criterion from among the plurality of the subject to be displayed.

5. The information processing device according to claim 1, wherein
the at least one processor
further detects, from within the text included in the display request page, a feature keyword expressing a feature of the subject to be displayed, and
adds, to the feature keyword within the text, a link to a page displaying the subject to be displayed, having the feature expressed by the feature keyword, as a list.

6. The information processing device according to claim 1, wherein the at least one processor adds, in the display request page, a link to a page displaying, as a list, each subject to be displayed identified by the detected keyword.

7. The information processing device according to claim 1, wherein
the subject to be displayed is a product, and
the keyword is information expressing the product, a group of the product, or a feature of the product.

8. A link adding method executed by an information processing device,
the information processing device comprising:
a memory storing a program; and
at least one processor that execute the program, wherein
the at least one processor
detects, from within text included in a display request page, for which displaying is requested from a terminal, a keyword associated with a subject to be displayed; and
adds, to the keyword within the text, a link to a page related to the subject to be displayed identified by the keyword.

9. The link adding method according to claim 8, wherein the at least one processor displays, on the terminal, the display request page including the keyword to which the link is added.

10. The link adding method according to claim 9, wherein the at least one processor displays, on the terminal, the display request page including the keyword to which the link is not added and then, at a predetermined timing, displays, on the terminal, the display request page including the keyword to which the link is added.

11. The link adding method according to claim 8, wherein in a case in which a keyword identifying a plurality of the subject to be displayed is detected, the at least one processor adds, to the keyword, a link to a page related to a representative subject to be displayed selected based on a predetermined criterion from among the plurality of the subject to be displayed.

12. The link adding method according to claim 8, wherein
the at least one processor
further detects, from within the text included in the display request page, a feature keyword expressing a feature of the subject to be displayed, and
adds, to the feature keyword within the text, a link to a page displaying the subject to be displayed, having the feature expressed by the feature keyword, as a list.

13. The link adding method according to claim 8, wherein the at least one processor adds, in the display request page, a link to a page displaying, as a list, each subject to be displayed identified by the detected keyword.

14. The link adding method according to claim 8, wherein
the subject to be displayed is a product, and
the keyword is information expressing the product, a group of the product, or a feature of the product.

15. A non-transitory non-volatile computer-readable recording medium storing a program that causes a computer to:
detect, from within text included in a display request page, for which displaying is requested from a terminal, a keyword associated with a subject to be displayed; and
add, to the keyword within the text, a link to a page related to the subject to be displayed identified by the keyword.
